(19) United States
(12) Patent Application Publication
(10) Pub. No.: US 2008/0190011 A1
(43) Pub. Date: Aug. 14, 2008

(54) BAIT HOLDER FOR USE WITH BAIT FISH

(75) Inventors: RYAN NEAL, Claremore, OK (US); MICAH JONES, JENS, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: W.C. BRADLEY/ZEBCO HOLDINGS, INC, TULSA, OK (US)

(21) Appl. No.: 11/673,869

(22) Filed: Feb. 12, 2007

(51) Int. Cl. A01K 97/05

(52) U.S. Cl. 43/56

(57) ABSTRACT

A device for transportation of live baitfish is disclosed. The device comprises a container having an interior portion and a plurality of strain holes such that the container holds water when sitting in an upright position but which allows water exchange with the interior portion when placed in a body of water. A strainer is disposed in the interior portion of the container and connected to at least one elevator rail. A releasable handle is attached to the at least one elevator rail and disposed substantially outside the container. The handle provides a grip for lifting and carrying the container when the handle is in a first unreleased state, and serves to elevate the strainer by lifting the at least one elevator rail when in a second released state.

### FIELD OF THE INVENTION

This disclosure relates to fishing equipment in general and, more specifically, to a device for transporting live bait.

### BACKGROUND OF THE INVENTION

When fishing, live baits may be preferred over artificial lures for various reasons. Live baits present a number of problems, particularly in handling, transporting, and storing the baits prior to and during their use. The baits must be kept alive or viable in less than ideal environments. The baits must be moved from their purchase or capture location to the fishing location. Once on location, the baits need to be easily accessible while being kept alive or viable.

What is needed is a system, method, and device for addressing the above and related issues.

### SUMMARY OF THE INVENTION

The present invention disclosed and claimed herein, in one aspect thereof comprises a device for transportation of live baitfish. The device comprises a container having an interior portion and a plurality of strain holes such that the container holds water when sitting in an upright position but which allows water exchange with the interior portion when placed in a body of water. A strainer is disposed in the interior portion of the container and is connected to at least one elevator rail. A releasable handle is attached to the at least one elevator rail and disposed substantially outside the container. The handle provides a grip for lifting and carrying the container when the handle is in a first unreleased state, and serves to elevate the strainer by lifting the at least one elevator rail when in a second released state.

The present invention disclosed and claimed herein, in another aspect thereof comprises a minnow submarine. The minnow submarine comprises a container with a substantially flat base and a plurality of water ports on an upper portion thereof such that the container may sit upright on a solid surface and contain an interior volume of water and may be placed in a body of water thereby allowing fluid communication between the body of water and the interior volume of water. A minnow strainer is within the container and may be moved between a first lower position and a second upper position for straining minnows from the interior body of water. A spring hinged door is provided on the container. The spring hinge is configured to hold the door closed and allow selective access to an interior of the container for accessing minnows. A handle is provided on the upper portion of the container. The handle extends by a series of rails into the interior of the container attaching to the strainer. The handle has a selective latch, and when the handle is unlatched it may be extended from the container thereby elevating the minnow strainer. A cam lever is provided on the door that interacts with a rail step on one of the series of rails to automatically open the door against the force of the spring hinge when the handle is extended from the container.

In some embodiments, when not extended, the handle of the minnow submarine also acts as a carry handle for the minnow submarine. The handle may be held in a closed position by the selective latch when being used as a carry handle. The latched handle may also be used as a tie-off point for securing the minnow submarine. When unlatched and extended, the handle both elevates the strainer and opens the normally closed spring hinged door.

### BRIEF DESCRIPTION OF THE DRAWINGS

The present invention is illustrated by way of example and is not limited by the figures of the accompanying drawings, in which like reference numbers indicate similar parts:

FIG. 1 is a frontal view of a live bait container according to aspects of the present disclosure.

FIG. 2 is a side cutaway along line 2 of FIG. 1.

FIG. 3 is a side view of the live bait container of FIG. 1.

FIG. 4 is a top down cutaway view taken along line 4 of FIG. 1.

FIG. 5 is another side cutaway view of a live bait container according to aspects of the present disclosure showing a partially extended handle and an open door.

FIG. 6 is another side cutaway view of a live bait container according to aspects of the present disclosure showing a fully extended handle and an open door.

FIG. 7 is a front cutaway of the upper portion of the live bait container of FIG. 3, taken along line 7 of FIG. 3

### DETAILED DESCRIPTION OF THE PREFERRED EMBODIMENTS

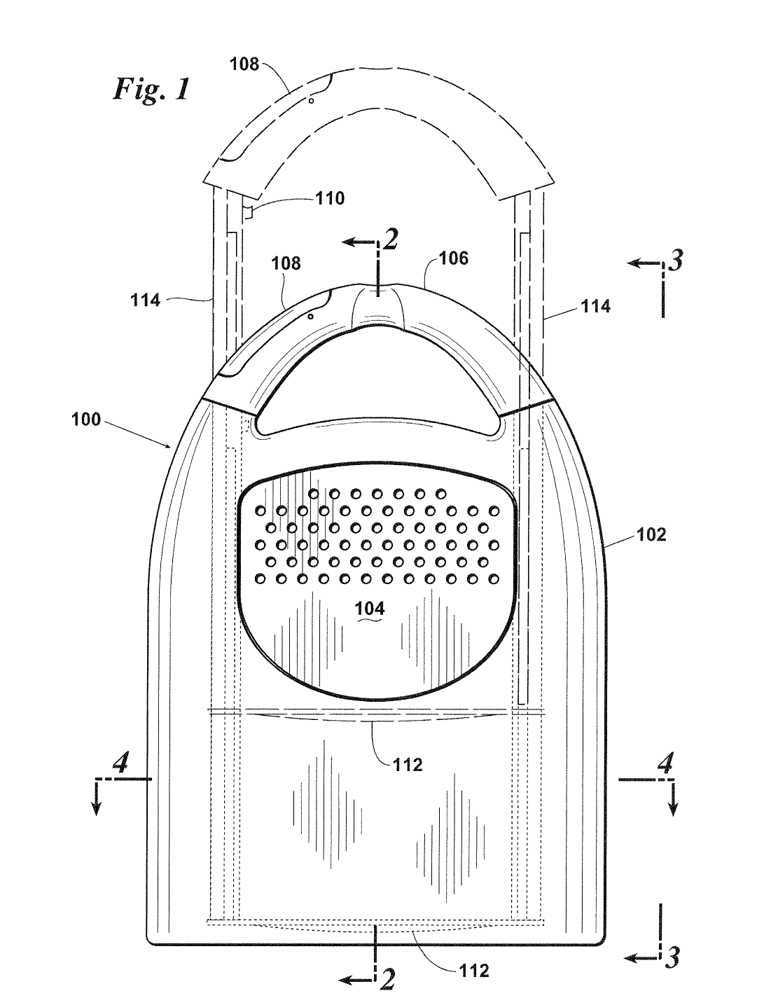

Referring now to FIG. 1, a frontal view of a live bait container according to aspects of the present disclosure is shown. In the present embodiment, the bait container takes the form of the minnow submarine 100 as shown in FIG. 1. Although the present disclosure describes a live bait container as a minnow submarine, it is understood that other kinds of live bait may be used with the methods and devices described herein. Examples of live bait with which devices of the present disclosure may be useful include, but are not limited to, minnows, goldfish, crawfish, shrimp, and/or other aquatic live bait. The minnow submarine 100 comprises a container 102 which may be the starting point to which the other features and devices as described herein are added.

The container 102 may be plastic or may be another material suitably resilient against submersion in water and/or storage in damp or wet environments. In the present embodiment, the container 102 provides a relatively flat base such that the container may be placed on the ground or another suitably hard surface and remain stable. As more fully described below, a portion of the container 102 may be provided with openings to allow the interexchange of water between the inside and the outside of the container. Thus, the minnow submarine 100 may be useful for both preserving and maintaining live bait fish in a dry environment while allowing the internal water reservoir to be refreshed when the minnow submarine is placed within a body of water. Such bodies of water may include, but are not limited to, lakes, ponds, streams, or live wells on board a fishing vessel.

The container 102 may be equipped with a bait door 104. The bait door 104 may be made of a similar or different material than the container 102. The bait door 104 may provide a series of openings to allow interexchange of water between the inside and the outside of the container 102 or to allow ventilation of the container 102. As can be seen in FIG. 1, a portion of the bait door 104, such as the lower portion, may be solid in order to minimize spillage or splashing of water out of the container 102. As will be explained in greater detail below, the bait door 104 may also be spring hinged. The bait door 104 may be spring hinged such as to allow selective access to the interior of the container 102 but normally returns to a closed position. As will be described in greater detail below, the bait door 104 may be configured such that the bait door 104 automatically opens in response to activation of other features of the minnow submarine 100, such as extension of a handle 106.

The handle 106 may be made from a similar or different material than the container 102. The handle 106 serves multiple functions in the embodiment shown. In a first, closed position, the handle 106 (as shown in FIG. 1 in solid line) serves as a lift handle such that the minnow submarine 100 may be transported from one location to another. The handle 106 also provides a location for tying a rope, cord, or other security line onto the minnow submarine 100. This may be useful for such purposes as placing the minnow submarine 100 into water while keeping it anchored to a boat or the shore. The handle may have ridges, indentations, or other features for aiding in tying a line thereto. The handle 106 may be textured or may be smooth or may comprise a different material altogether than the container 102. The handle 106 may be equipped with a release button 108 which allows the handle 106 to be extended away from the container 102 (as shown in dotted line in FIG. 1). In some embodiments, the release button 108 will be flush with, or recessed into, the handle 106 to prevent accidental release of the handle 106. When the handle 106 is extended, a handle catch 110 can be seen. The catch 110 serves, in the present embodiment, to secure the handle 106 to the container 102 when the handle 106 is in the closed position. In some embodiments, the release 108 must be depressed to disengage the catch 110 prior to extending the handle 106.

Inside the container 102, as shown in dotted and dashed line, a bait strainer 112 is shown in two positions. The lower dotted line drawing of the bait strainer 112 illustrates the bait strainer 112 in a first, lower position while the dashed line drawing of the bait strainer 112 shows the bait strainer 112 in an upper or extended position. It can be seen that a set of rails 114 extend from the handle 106 down to the bait strainer 112. Thus, when the handle 106 is extended away from the container 102, the bait strainer 112 moves from the first, lower position to the second, upper position. As stated previously, in the present embodiment the bait door 104 also opens in response to the handle 106 being extended away from the container 102. It can therefore be seen that by depressing the release 108 and extending the handle 106, a user of the minnow submarine 100 will simultaneously open the bait door 104 while moving the strainer 112 from a lower position to an upper position inside the container 102. This will result in any bait fish stored within the container 102 being strained out of the water and elevated up near the now open door 104. Thus, a user may quickly and easily gain access to bait fish contained within the minnow submarine 100 by simply extending the handle 106. After obtaining the desired bait fish from the minnow submarine 100, the user may return the handle 106 to its non-extended position, which will result in the bait door 104 closing as the strainer 112 moves back into a lower position. The bait fish stored within the container 102 may once again be stored in water contained in the container 102.

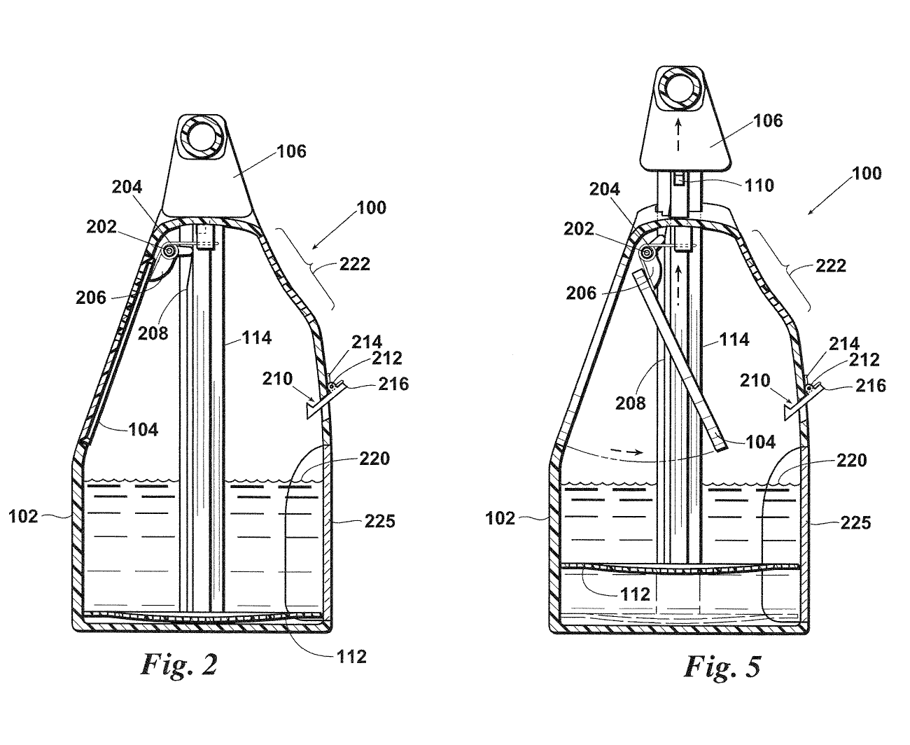

Referring now to FIG. 2, a side cutaway along the line 2 in FIG. 1 is illustrated. Here the minnow submarine 100 can be seen with the bait door 104 in a closed position. A door hinge 202 is used to located and move the bait door 104. The door hinge 202 may be a metal hinge or another suitable type of hinge. As stated, the door 104 may be spring loaded by the door spring 204, for example. The door spring 204 is shown in the present embodiment as a coil spring, but other spring types are contemplated. Attaching the bait door 104 to the door hinge 202 is a door slide lever 206. The slide lever 206 serves as a cam lever acting against the rail step 208 (integrated with the strainer rail 114) to open the bait door 104 in response to the handle 106 being extended. The slide lever 206 rests against the rail step 208 but is not necessarily attached thereto. This allows the bait door 104 to be opened with pressure from the outside whether the handle 106 is in a closed or extended position. In the view of FIG. 2, only a single slide lever 206 and a single rail step 208 are shown, but it is understood, as can be seen in the other drawings, that a slide lever and a rail step may be provided on both sides of the minnow submarine 100.

As described, the bait door 104 may be pressed open by the user whether or not the handle 106 is in an extended or closed position. In some instances, the user may wish for the bait door 104 to be retained in an open position to allow easier access to the contents of the minnow submarine 100. A door latch or catch 210 may therefore be provided in a position to catch and retain the bait door 104 in an open position. A hinge 212 may be provided as well as a spring 214. Thus, the bait door 104 may be engaged with the door catch 210 and held securely thereby. A catch-release tab 216 may be provided on the door catch 210, which may be used to overcome the force of the spring 214, thereby releasing the bait door 104. In other embodiments, the door catch 210 may simply be made from a flexible material, eliminating the need for the hinge 212 and the spring 214. It can be appreciated from FIG. 2 that the bait door 104 may be pushed open and retained by the door catch 210 and the door may be released by the release tab 216 without the need for the user to reach into the interior of the minnow submarine 100. It can also be seen from FIG. 2 that the container 102 is adapted to contain a volume of water 220 even when stored outside the separate body of water.

Additional features of the container 102 which may be seen from the view of FIG. 2 include the holes or water portals 222. The water portals 222 serve to allow the interexchange of water between the outside of the container 102 and the volume of water 220 contained within the container 102. Therefore, the minnow submarine 100 may be submerged or otherwise placed in a body of water for refreshing or exchanging the volume of water 220 contained therein. A translucent panel 225 may also be provided on the container 102. The translucent panel 225 may be a plastic or other resilient and suitably clear material that allows the user to view the contents of the minnow submarine 100. In other embodiments, all of part of the container 102 itself may be translucent.

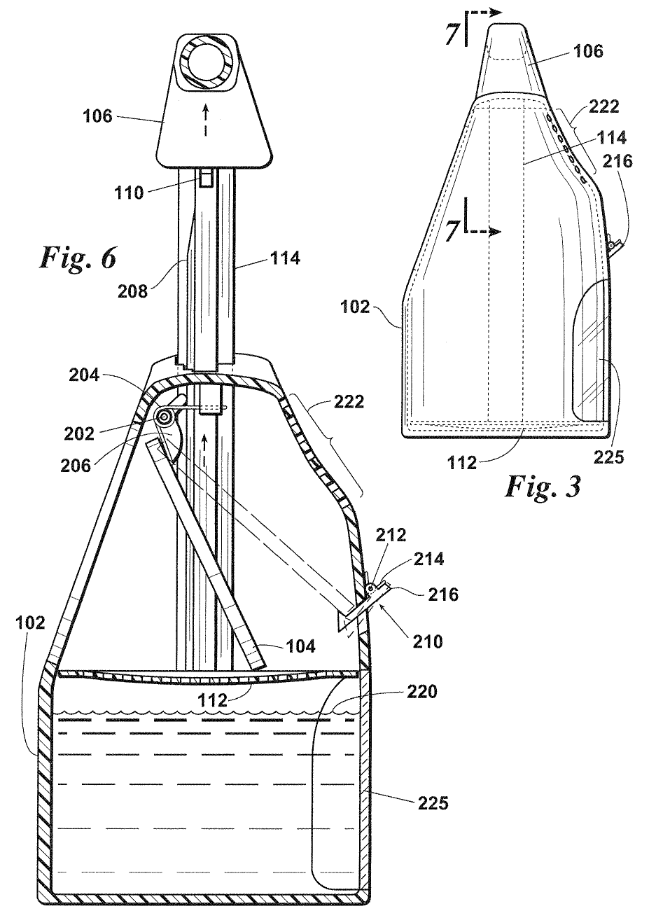

Referring now to FIG. 3, a side view of the live bait container of FIG. 1 is shown. In the view of FIG. 3, the handle 106 is shown in the closed or non-extended position. The internal position of the rails 114 and the strainer 112 are shown in dotted line. From this view, it can also be seen that the release tab 216 is accessible from the outside of the container 102. The translucent window 225 allowing a view of the interior of the container 102 is also shown. It can be appreciated from this view point that the water portals 222 may simply be a series of holes defined by the container 102. These holes may be formed by being integrated into the casting or molding process of the container 102, or may be added by drilling or other machining methods.

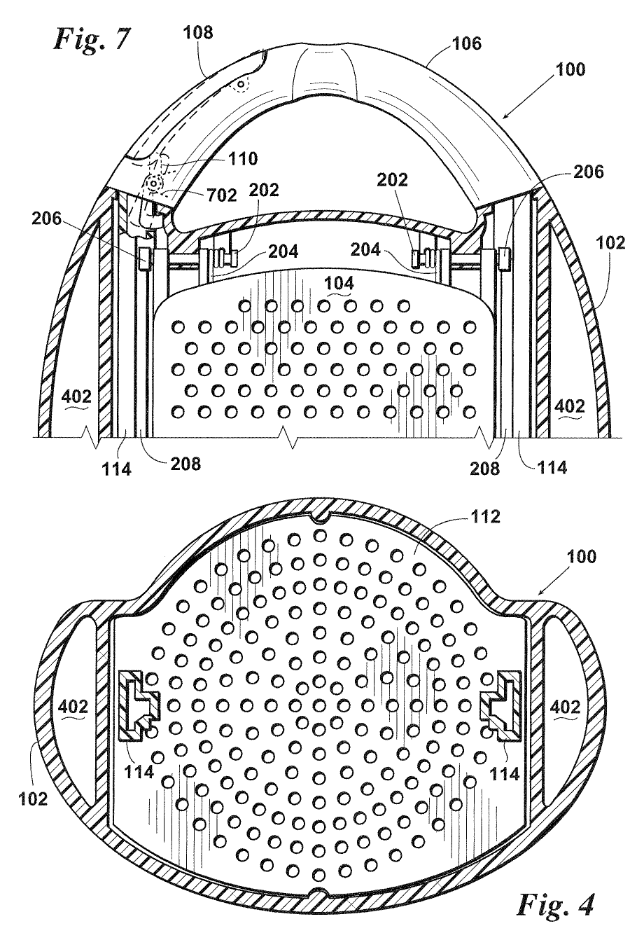

Referring now to FIG. 4, a top down cutaway view taken along line 4 of FIG. 1 is shown. Here, the container 102 is shown in a horizontal cross-section. Here, it can be seen that two or more rails 114 extend through the container 102 to the strainer 112. The strainer 112 may be formed with a number of holes therein that allow water to pass through while retaining any bait fish on the strainer 112. In some embodiments, the strainer 112 may be removable to allow cleaning of the strainer 112 or for other reasons. The strainer 112 may also have a removable panel (not shown) to allow access under the strainer. Access under the strainer may be achieved by allowing the strainer 112 to elevate above at least a portion of the opening in the body 102 for the bait door 104 when the handle is extended. A number of empty compartments 402 may be defined by the body of the container 102. The compartments 402 may be configured to act as ballast tanks or as float tanks for the minnow submarine 100. The strainer 112 may be configured to conform generally to the shape of the interior of the container 102 that is not occupied by the compartments 402. In other embodiments, the shape of the strainer 112 may be different than shown to allow for easier removal of the strainer 112 from the container 102. In some embodiments, the size of the holes of the strainer 112 as well as the tolerance between the edges of the strainer 112 and the container 102 must be chosen to correspond to the size of the bait fish being used.

Referring now to FIG. 5, another side cutaway view of a live bait container according to aspects of the present disclosure is shown. FIG. 5 illustrates the handle 106 in a partially extended position. The handle 106 has been extended to such a degree as to open the bait door 104. It can be seen that the rail step 208 has displaced the slide lever 206, forcing the bait door 104 open against the resistance of the spring 204. It can also be seen that the extension of the handle 106 has begun to cause an elevation of the strainer 112. In the embodiment shown, the opening of the bait door 104 may be complete before the strainer 112 is fully raised to an elevated position. In this embodiment, the user is allowed to partially extend the handle 106 opening the bait door 104 while choosing the degree of extension of the handle 106 that corresponds to the desired elevation of the strainer 112.

Referring now to FIG. 6, another side cutaway view of a live bait container according to aspects of the present disclosure is shown. FIG. 6 illustrates the handle 106 having been fully extended, thereby fully elevating the strainer 112. From this view, it can be seen that the elevation of the strainer 112 may be limited by interference with the contours of the container 102 or with the bait door 104. In other embodiments, other means to limit the elevation of the strainer 112 may or may not be provided. Also, as shown in dashed line, the bait door 104 may be further opened by hand to engage the door catch 210. It can be seen that when the bait door 104 is engaged by the door catch 210, the strainer 112 moves independently of the bait door 104 in response to movement of the handle 106. Thus, the bait door 104 may be opened completely with or without elevation of the strainer 112.

Referring now to FIG. 7, a front cutaway of the upper portion of the live bait container of FIG. 3 taken along line 7 of FIG. 3 is shown. The view of FIG. 7 illustrates one possible implementation of the upper mechanism of the minnow submarine 100. The release 108 is shown in solid line in its normal position and shown in dashed line in its depressed or activated position. Similarly, the handle catch 110 is shown in normal and displaced positions. A spring 702 may be used to bias the release 108 and/or the handle catch 110. This spring may be used to bias the handle catch 110 and the release 108. The handle catch 110 displaces and then engages the body of the container 102 when the handle 106 is moved to the closed position. The spring 702 is shown as a coil spring, but other springs may be used in other embodiments. The open compartments (ballast or flotation tanks) 402 can also be seen in this cutaway view. The door slide levers 206 may be seen against the rail steps 208 on the strainer rails 114. The door hinges 202 can also be seen with the door springs 204 biasing the bait door 104 in a closed position. It will be appreciated that FIG. 7 illustrates only one possible mechanical implementation of the functionality described herein and that other embodiments are possible.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A device for transportation of live baitfish, the device comprising:
a container having an interior portion and a plurality of strain holes such that the container holds water when sitting in an upright position but which allows water exchange with the interior portion when placed in a body of water;
a strainer disposed in the interior portion of the container and connected to at least one elevator rail; and
a releasable handle attached to the at least one elevator rail and disposed substantially outside the container;
wherein the handle provides a grip for lifting and carrying the container when the handle is in a first unreleased state, and serves to elevate the strainer by lifting the at least one elevator rail when in a second released state.

2. The device of claim 1, further comprising a spring hinged access door providing access to the interior portion of the container.

3. The device of claim 2, further comprising:
a cam lever attached to the access door proximate the at least one elevator rail; and
a rail step integrated with the at least one elevator rail;
wherein the rail step actuates the cam lever when the at least one elevator rail is lifted by the handle, the actuated cam lever opening the access door against the force of the spring hinge.

4. The device of claim 2, further comprising a latch adapted to hold the access door in an open position.

5. The device of claim 1, further comprising a translucent window on the container.

6. The device of claim 1, wherein the handle is releasable via an integrated thumb release.

7. The device of claim 1, wherein the strainer is selectively removable from the container.

8. The device of claim 1, wherein the container defines one or more air and water tight ballast compartments.

9. A minnow submarine comprising:
a container with a substantially flat base and a plurality of water ports on an upper portion thereof such that the container may sit upright on a solid surface and contain an interior volume of water and may be placed in a body of water thereby allowing fluid communication between the body of water and the interior volume of water;
a minnow strainer within the container that may be moved between a first lower position and a second upper position for straining minnows from the interior body of water;
a spring hinged door on the container, the spring hinge configured to hold the door closed and allow selective access to an interior of the container for accessing minnows; and
a handle on the upper portion of the container, the handle extending by a series of rails into the interior of the container and attaching to the strainer;
wherein the handle has a selective handle latch, and when the handle is unlatched it may be extended from the container thereby elevating the minnow strainer; and
wherein a cam lever is provided on the door that interacts with a rail step on one of the series of rails to automatically open the door against the force of the spring hinge when the handle is extended from the container.

10. The minnow submarine of claim 9, wherein the spring hinged door provides a plurality of water ports.

11. The minnow submarine of claim 9,wherein the container further comprises a selectively releasable door latch configured to hold the door in an open position.

12. The minnow submarine of claim 9, wherein the selective latch is normally closed via a latch spring thereby preventing the handle from being drawing away from the container.

13. The minnow submarine of claim 12, wherein the selective latch may be unlatch by depressing a thumb release on the handle.

14. The minnow submarine of claim 9, wherein the container further comprises a window to allow viewing contents of the container.

15. The minnow submarine of claim 9, wherein the strainer is selectively removable from the container.

16. A minnow submarine comprising:
a container with a substantially flat base and a plurality of water ports on an upper portion thereof such that the container may sit upright on a solid surface and contain an interior volume of water and may be placed in a body of water thereby allowing fluid communication between the body of water and the interior volume of water;
a spring hinged door to the water tight container, the door being normally closed and allowing selective access to the interior of the container;
a strainer inside the container aligned with the substantially flat base of the container and connected to a pair of rails extending from the strainer through the upper portion of the container and attaching to a handle;
wherein the handle:
provides a surface for tying on a security line;
may be selectively locked onto the container and utilized as a carry handle; and
may be selectively unlocked from the container and used to elevate the strainer through the container; and
wherein the spring hinged door further comprises at least one cam lever that interacts with a rail step on at least one of the pair of rails to force the spring hinged door open when the strainer is elevated through the container.

17. The minnow submarine of claim 16, wherein the container has at least one substantially translucent portion.

18. The minnow submarine of claim 16, wherein the spring hinged door is substantially translucent.

19. The minnow submarine of claim 16, wherein the spring hinged door further comprises a plurality of water ports.

20. The minnow submarine of claim 16, wherein the container defines at least one water tight ballast tank.
